(19) United States
(12) Patent Application Publication
(10) Pub. No.: US 2015/0302328 A1
(43) Pub. Date: Oct. 22, 2015

(54) Work Environment Recommendation Based on Worker Interaction Graph

(71) Applicant: HEWLETT-PACKARD DEVELOPMENT COMPANY, L.P., Houston, TX (US)

(72) Inventors: Jun Zeng, Palo Alto, CA (US); Francisco Oblea, Tlaquepaque Jalisco (MX); Gideon Amir, Nes Ziona (IL); Noam Shaham, Ness Ziona (IL)

(21) Appl. No.: 14/443,668

(22) PCT Filed: Nov. 29, 2012
(86) PCT No.: PCT/US2012/067016

§ 371 Date: May 19, 2015

(51) Int. Cl. G06Q 10/06

(52) U.S. Cl. CPC G06Q 10/0639

(57) ABSTRACT

Examples disclosed herein relate to a work environment recommendation based on a worker interaction graph. A computing device may determine based on a graph representing relationships between workers, productivity information related to a work environment and determine a suggested change to the work environment based on the productivity information. The computing device may output the suggested change.

### BACKGROUND

Factory management may involve coordinating a large number of workers and equipment. In some cases, factories rely heavily on manual labor with workers interacting with one another to produce the work product. Factory management may involve coordinating the activities of the many workers, which in some cases may be a large number of temporary workers.

### BRIEF DESCRIPTION OF THE DRAWINGS

The drawings describe example embodiments. The following detailed description references the drawings, wherein:

FIG. 1 is a block diagram illustrating one example of a computing system to suggest a work environment recommendation based on a worker interaction graph.

FIG. 2 is a flow chart illustrating one example of a method to suggest a work environment recommendation based on a worker interaction graph.

FIG. 3A is a diagram illustrating one example of a social networking graph of a work environment.

FIG. 3B is a diagram illustrating one example of a recommended change to a work environment based on a social networking graph of a work environment.

### DETAILED DESCRIPTION

In one implementation, a social networking graph indicating relationships between workers in a work environment is automatically analyzed to determine recommendations for the work environment. For example, a processor may make a recommendation on how to alter tasks, workers, worker organization, or process workflow based on an analysis of the interactivity graph. The graph may be, for example, a hand off graph with nodes representing workers and edges representing work product hand off or other interactions between the workers.

In a work environment using a large amount of manual labor, it may be complicated to optimize the work environment. For example, it may be more difficult to track how work is completed and the connectivity between the different work being performed. It may also be more difficult to assess the best work flow in a manual process. In addition, a manual labor force may include more frequent changes, such as new workers or temporary workers. Different workers in the same position may perform differently with a different process or different productivity level. Manual labor may be used in custom order environments, which further complicates the ability to provide a big picture of the productivity of the system as a whole. A social network of a work environment may be used to provide an analysis of worker contribution and influence resulting in recommendations leading to greater workforce efficiency.

A print service provider work environment is an example work environment where an automated social networking recommendation method may be used effectively. A print service provider often scales up and down based on demand by using seasonal workers that may be trained on the job. The orders are often custom orders where the same item is not made repeatedly. Due to the ad hoc manual nature of production the planned production and the actual process may differ. A social networking approach that focuses on interactions between the workforce instead of or in addition to manufacturing processes may benefit work environments similar to print service providers. A social networking recommendation method may also provide benefits for other types of non-factory based work environments, such as a software development work environment where many workers each produce a small piece of computer code that fits together in a larger computer program.

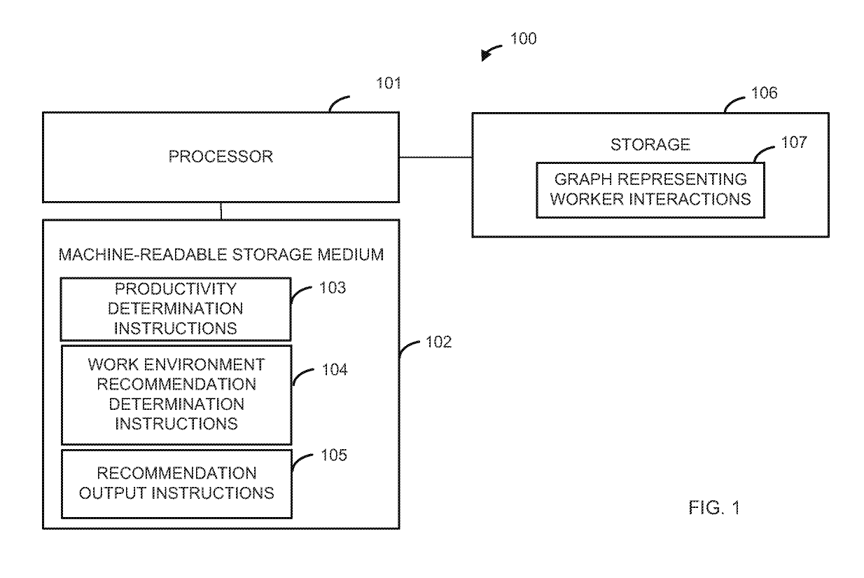

FIG. 1 is a block diagram of a computing system to suggest a work environment recommendation based on a worker interaction graph. The computing system 100 includes a processor 101, a machine-readable storage medium 102, and a storage 106. The computing system 100 may be included in a single apparatus or may involve multiple devices communicating with one another, such as via a network. In one implementation, the processor 101 provides a cloud service. For example, the processor 101 may be part of a server that provides information to a client computing device.

The processor 101 may be a central processing unit (CPU), a semiconductor-based microprocessor, or any other device suitable for retrieval and execution of instructions. As an alternative or in addition to fetching, decoding, and executing instructions, the processor 101 may include one or more integrated circuits (ICs) or other electronic circuits that comprise a plurality of electronic components for performing the functionality described below. The functionality described below may be performed by multiple processors.

The storage 106 may be included within the machine-readable storage medium 102 or may be a separate storage device. The storage 106 may be a storage remote from the processor that the processor 101 communicates with via a network. The storage 106 may store a graph 107 representing worker interactions. For example, the graph 107 may include a graph with nodes representing workers and edges representing interactions between the workers. The graph 107 may be a directed or undirected graph. For example, the graph 107 may be a directed hand off graph with the edges representing the direction of work product being passed from one worker node to another worker node. The storage may include additional information about the work environment, such as the roles of the workers, the times that a worker receives and hands off work product, or the relative location of the workers. In one implementation, the graph 107 includes time stamp information or other additional information associated with the edges.

The graph 107 may be stored in any suitable manner. For example, the graph 107 may be stored as a table of nodes and a table of relationships between the nodes. The graph 107 may be stored in an XML file.

The graph 107 may be created by the processor 101 or by another processor. The graph 107 may be created in response to a user request or periodically on a time schedule. For example, a new graph may be created each week, and the new graph may then be optimized. The graph 107 may change based on seasonality of the work, the type of orders, or the number of workers. The graph 107 may be automatically created from a work environment event log. For example, the log may include process, event time stamp, worker id, and job id information. The log information based on tasks may be translated to a social networking interaction graph. In one implementation, preprocessing is performed on the log prior to creating the graph 107. For example, duplicate entries may be removed. In some cases, multiple graphs may be created where each focuses on a different metric, subset of workers, or task.

The graph 107 may be viewable by a user, and may be viewed as a snapshot or as a movie showing changes over time. The graph 107 may be designed to reveal information about the manufacturing process as a whole or from the perspective of the contribution of a worker or set of workers.

The processor 101 may communicate with the machine-readable storage medium 102. The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 102 may be, for example, a computer readable non-transitory medium.

The machine-readable storage medium 102 may include instructions executable by the processor 101, such as productivity determination instructions 103, work environment recommendation determination instructions 104, and recommendation output instructions 105. The productivity determination instructions 103 include instructions to analyze the graph 107 to determine information about the productivity of the work environment. For example, the productivity may take into account the time work product remains with a worker until moving to the next, the role of workers, the relative location of workers, the priority or workers and other information useful for analyzing the productivity of the work environment. The productivity information may include, for example, time, efficiency, number of workers used, and number of resources in the work environment.

The work environment recommendation determination instructions 104 may include instructions to recommend a change to the work environment based on the analysis of the productivity of the work environment. For example, the recommendation may involve how to alter tasks, worker organization, or process workflow based on an analysis of the interactivity graph 107. The recommendation may involve changing the role or location of an individual worker, changing the order of tasks, changing the production workflow for particular types of products, or changing the tools or number of people for performing a task.

The recommendation output instructions 105 may include instructions to output the recommendation. For example, the recommendation may be displayed, transmitted, or stored. In one implementation, the recommendation is displayed with the graph 107.

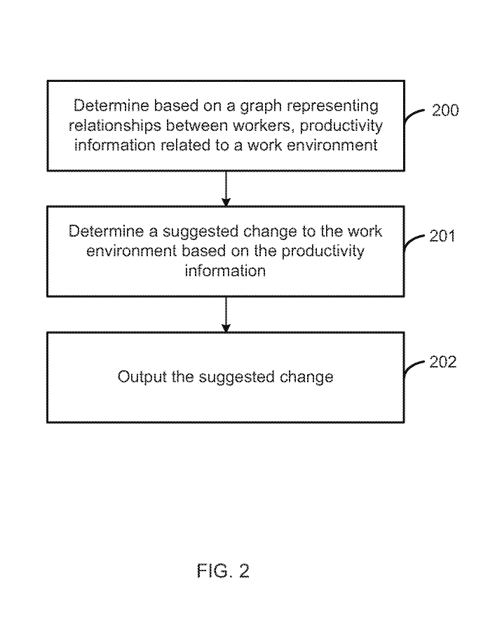

FIG. 2 is a flow chart illustrating one example of a method to suggest a work environment recommendation based on a worker interaction graph. The worker interaction graph may reflect a social network of how employees interact with one another in a work environment. The recommended change may be related to altering, for example tasks, worker organization, or process workflow based on an evaluation of the graph. The method may be implemented, for example, by the processor 101.

Beginning at 200, a processor determines, based on a graph representing relationships between workers, productivity information related to a work environment. The graph may be any suitable graph representing the interactions between workers in the work environment. For example, the graph may include nodes representing workers or sets of workers with lines between the nodes representing an interaction between the workers represented by the nodes. The graph may be a directed hand off graph representing the flow of work product, tools, or information from one worker to another.

The graph may be created by the processor making the recommendation or by another processor. For example, the processor may receive the graph from a network or retrieve the graph from a storage. The graph may be created based on work log information related to the work environment. For example, an event log may include some information about interactions between workers, but an event log may not provide a bigger picture view of the social network of the work environment that may be evident from the social networking graph.

The productivity information may be any suitable information related to the work being performed in the work environment. For example, the productivity information may relate to the location of workers, the importance of particular workers, the flow of work between the workers, the efficiency of workers, or the use of materials or equipment between workers.

Continuing to 201, a processor determines a suggested change to the work environment based on the productivity information. For example, the suggested change may involve hiring more workers, using fewer workers, moving the order of workers in a process, assigning a worker to a different group, changing the relative location of workers, or changing a process from a sequential order to a parallel order. The processor may determine the suggested change in any suitable manner. The processor may use a database look up method, clustering method, optimization method, and/or machine learning method to determine a change to the work environment.

In one implementation, the productivity information includes identifying a higher priority of a worker. For example, a high priority worker may be a worker handing a large amount of work to other workers and/or receiving a large amount of work from other workers. The processor may determine a high priority worker based on the number of edges going into or coming out of a node representing a worker. The edges may represent the amount of work handed to the worker or passed from the worker to another worker. Similarly, the processor may determine a high priority group of workers, such as a department.

The processor may determine a high priority worker based on a threshold. For example, a threshold may be that a worker receives work from more than 10 workers or receives work from any number of workers more than 10 times per hour. In one implementation, the amount of work or number or workers interacting with a worker is determined for each worker node, and the top number or percentage of workers are marked as high priority, such as the top 5 workers or top 1 percent.

The priority of a worker may be determined based on a normalized sum of the shortest distances between a worker node and any other nodes measuring how close the node is at the center of the social network. The priority of a worker may be determined based on a between-ness of the graph given by a probability of a node to occur on a randomly chosen shortest path between two randomly chosen nodes.

In one implementation, the processor examines whether workers work together serially or in parallel based on the edges in the graph. The processor may examine the process to determine a priority worker that is a gatekeeper to a larger part of the process. A person may be prioritized as one of a few with particular knowledge, such as knowledge of how to operate a particular piece of equipment or how to perform a particular task.

The processor may determine a recommendation based on the identified high priority worker. The processor may access a database with stored suggestions related to identified high priority workers. For example, a worker above a threshold of work may be associated with a recommendation to add a worker, to split the work between two workers, to prepare for the circumstance of the worker leaving, or to provide more training to the high priority worker. In one implementation, the processor accounts for other factors to make a specialized recommendation for the particular high priority worker. For example, the processor may model splitting the particular task of the high priority worker into multiple steps divided between multiple workers.

In one implementation, the processor analyzes the overall utilization of workers, such as workers identified as high priority workers due to more connections in the graph. For example, the processor may recommend a change to the setup such that one worker is more involved in the process and another is involved less where one worker appears to have many edges coming into it.

Similarly, the processor may determine high priority equipment that may lead to a bottleneck in some processes. The processor may compare the use of the equipment to a threshold or may compare the time a worker is waiting to use the equipment. The processor may recommend purchasing more equipment or altering the order of a process. In one implementation, the processor evaluates how workers share resources. For example, workers may share the same tool or equipment. The processor may recommend an order of performing work based on the manner in which tools are shared.

In one implementation, the processor determines productivity information related to the effectiveness of a worker. For example, the graph may be a directed graph of work product of work flow between worker nodes. The work may typically flow in one direction down an assembly line, and a flow back in the opposite direction may indicate that the previous worker was asked to redo a portion of the work. The processor may compare the nodes a threshold, such as where more than 10 pieces of work or returned or more than 10 percent of work is returned indicates that a suggestion be made related to the particular worker. For example, the suggestion may be related to improving the worker's skills through training, adding more workers for the particular production step, upgrading equipment involved in the step, making changes to the production workflow to reduce the use of the step, or making changes to the production workflow to reduce the faulty rate of the step.

The processor may make a suggestion based on worker effectiveness. There may be multiple thresholds, and the process may compare the hand off amount or rate to a database associating the thresholds with recommendations. For example, a first threshold may be associated with a recommendation for additional worker training and a second higher threshold may be associated with a recommendation to replace the worker.

In one implementation, the processor determines productivity information related to the frequency of interaction between workers or sets of workers. For example, the processor may compare the amount of interactions between two workers and compare it to a threshold. The threshold may be related to a number of interactions, a percentage of interactions of the particular workers, or a number of interactions compared to an average for all workers. The processor may perform a pair-wise comparison of sets of two workers. The processor may perform an automatic clustering method to cluster workers and compare interactions between the clusters. The processor may cluster the workers based on user indicated information, such as stored information clustering the workers based on role or department.

The processor may determine a suggested change based on the interaction frequency productivity information. For example, the processor may identify workers with an interaction frequency above a threshold and determine the relative location of the workers. If the workers are greater than a particular distance apart, the processor may recommend a change in location for one or both of the workers.

In one implementation, the processor models the work environment floor plan based on the frequency interaction information and outputs the top number of floor plans that reduce the space between workers that frequently interact with one another.

In one implementation, the processor determines a recommendation for a process change based on the relative location of the frequently interacting workers. For example, if the frequency interaction between two workers is above a threshold and a distance between the two workers is above a threshold, the processor may recommend rerouting some work product.

In one implementation, the processor evaluates productivity information related to “up time” and idle time for work product or workers. For example, the processor may compare the amount of time of the day spent idle as compared to working for a particular worker. If the idle time is above a threshold, above a percentage threshold for a group of workers, or in the top number of workers, the processor may make a suggested change. The change may relate to a particular worker. For example, the processor may recommend training for the worker or a new role for the particular worker. In one implementation, the change is related to workflow. For example, the processor may use the information about the time for workers to complete the tasks to model different workflows, such as a process performed sequentially, in parallel, or in a different order. The processor may model different processes and output a top number with the least idle time. The processor may identify edges in the graph that exceed a particular period of time and may further look at those that exceed a particular frequency.

In one implementation, the processor compares a social networking graph to a formal process graph and identifies the differences. The processor may make a recommendation for altering the actual factory set up to mirror that of the formal process design or may recommend altering the formal process design. For example, the processor may compare the two to determine which is more efficient.

In one implementation, the processor determines productivity information related to the likelihood of success or failure of relationships between workers. For example, the processor may identify a worker who is difficult to work with due to lower quality work product, longer production time, or more hand backs from other workers when the particular worker is involved. The processor may suggest a change to pair fewer people with the unsuccessful worker or form fewer similar relationships.

In some cases, the processor may identify a particular type of relationship may be as one likely to result in success. For example, pairing a particular type of worker together may result in higher quality work, shorter production time, or fewer hand backs. The processor may suggest a change to pair more people with the successful worker or form more similar relationships. In one implementation, the processor determines the contribution of a worker based on a correlation of the worker and the performance of others that the worker works with.

In one implementation, the productivity information relates to comparing workers in the same role to determine their productivity level. The processor may recommend a new role for a worker performing below a threshold. In one implementation, the productivity information relates to comparing the work performed by a worker to a former role description, such a stored description. The processor may compare multiple people in the role to see if the tasks are the same or similar. If not, the processor may recommend a new role or department for some of the workers or may recommend a task list to associate with each of the roles.

In one implementation, the processor evaluates how workers work together. For example, the processor may analyze how many workers work together on a particular task, and the processor may recommend breaking apart the workers and creating separate processes or fewer workers on the task where the number is above a threshold. In some cases, the threshold may be specific to a particular task. The processor may determine clusters within the graph where workers largely work within one another in the cluster. The processor may recommend changing roles if the clusters do not correspond to a formal stored process.

In one implementation, the processor evaluates productivity information related to particular types of tasks. For example, the processor may compare the creation of projects using more high level versus routine skills. The processor may output a recommendation for how to structure the work environment for the particular type of task or task skill level.

In one implementation, the processor compares productivity information related to two time periods. For example, the processor may make a first recommendation for a first time period and a second recommendation for a second time period. Some time periods may include greater orders or a greater staffing level, such as during a busy season. In some cases, an individual may be analyzed to determine how the worker performs during higher volume or times of higher stress. For example, the processor may determine if the worker has more hand backs from other workers during high volume time periods. If so, the processor may recommend making a change to the worker's tasks during peak volume. Similarly, the processor may compare the graph during times where different types of orders are being made. For example, in a custom order factory, the types of orders may vary at different times.

Multiple types of productivity information may be taken into account. For example, the processor may determine work flow suggestions based on worker location, role, and high priority workers. Any combination of the productivity information discussed above may be created. In one implementation, a user interface is displayed that allows a user to indicate which factors to take into account. A user interface may allow a user to request particular types of suggestions, such as suggestions related to floor plan, process, or worker roles.

Moving to 202, a processor outputs the suggested change. The suggested change may be output in any suitable manner. For example, the processor may store, transmit, or display the suggested change information. In one implementation, the processor determines multiple suggested changes and displays them to a user. For example, the processor may assign a score to multiple work environment worker location options and display or otherwise output the five with the top scores.

In one implementation, the graph is displayed to a user in a manner that reflects the productivity information. For example, a node or edge may be highlighted to reflect its importance in the productivity of the work environment as a whole. In one implementation, the graph is displayed to show a suggested change. For example, a graph showing a current setup may be displayed next to a graph with the suggested setup or process.

The nodes in the graph may be shown with the worker or department name. The nodes and edges may have different colors, sizes, and other visual features to convey information to a viewer. As an example, a normal process may be shown with a black edge, and a hand over leading to failure or rework may be shown in red. As another example, the thickness of an edge may represent the frequency of the particular interaction.

In one implementation, a Fruchterman-Reingold method is used to layout the nodes using attractive and repulsive forces defined between any two nodes. An iterative procedure may be used to find the position of each node in the graph. The attractive and repulsive forces may be defined based on a particular attribute. For example, for determining the centrality of a worker, the repulsive force between two nodes may be proportional to the centrality of both nodes and inversely proportional to the square of the distance.

In one implementation, a processor generates a user interface allowing a user to make selections as to what type of graph will be viewed. For example, a user may select a time period or a type of activity to view. The user may select a subset of the workers or projects to view. For example, the user may want to view how a new worker fits into the process. The user may view a snapshot before and after an event or a movie showing changes in the process in response to the event.

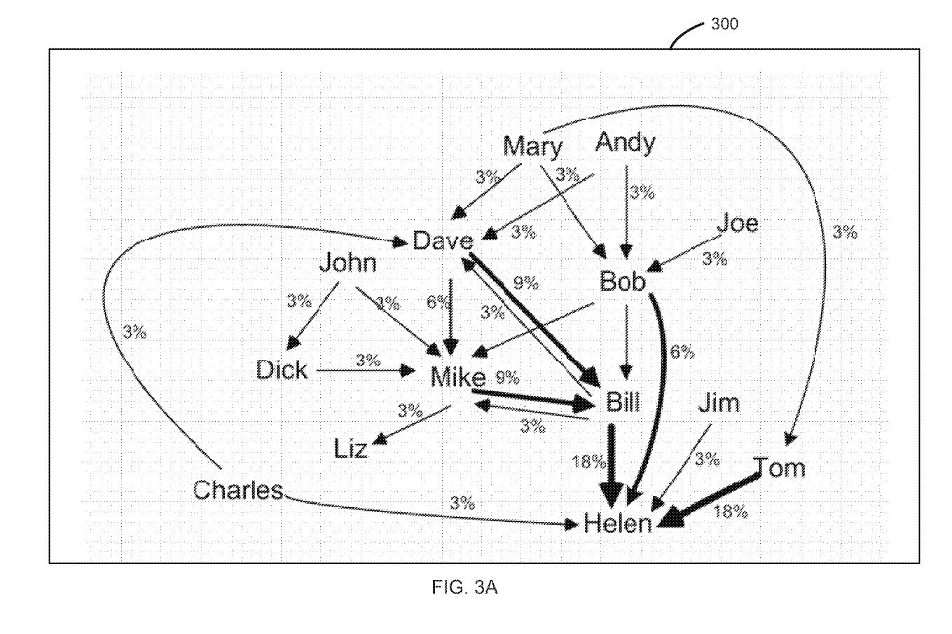

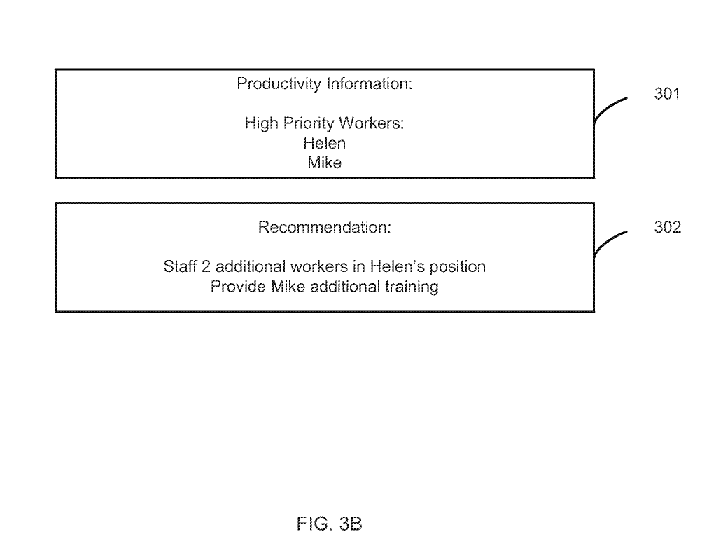

FIG. 3A is a diagram illustrating one example of a social networking graph 300 of a work environment. For example, the social networking graph 300 includes nodes for multiple workers, such as a node for Dave, Mary, Andy, and Bob. The directed edges between the nodes show the flow of interactions between the workers, such as the handing of work product from one worker to the next. The thickness of the edges represents the percentage of interactions of the work environment are between the two workers, and the percentages are also shown next to the edge. For example, Bill handing work product to Helen may involve 18% of the interactions in the work environment. The edges between Dave and Bill show that 9% of the work goes from Dave to Bill and 3% from Bill to Dave. The graph my include information as to which of that work includes hand back of the same work. For example, the proper process may be from Dave to Bill, and the 3% from Bill to Dave may be work that Bill sent back for Dave to redo. The social networking graph 300 may be a graph displayed to a user in charge of managing a factory environment.

FIG. 3B is a diagram illustrating one example of a recommended change to a work environment based on the social networking graph of FIG. 3A. Block 301 shows productivity information determined based on the social networking graph 300. The productivity information includes identifying Helen and Mike as high priority workers. For example, a large percentage of the work goes through Helen and is completed there. She may be identified as a high priority worker because she receives a large portion of work and because the portion she receives is not sent on to someone else to review. The processor may identify Mike as a high priority worker because a large amount of work is handed to him, and 10% of the interactions in the environment involve him handing work to other workers.

Block 302 shows an automatically determined recommendation based on the productivity information. For example, the recommendation may involve hiring two additional workers to staff Helen's position and to provide Mike additional training. The recommendations may be different based on the level of priority of the workers. Other factors may also be taken into account, such as the amount of time work product sits idle while a worker works on another project.

The recommendation may be provided to a viewer. A social networking graph and recommendation may be useful for work environment management. A viewer may receive a recommendation for a change to be carried out on a factory floor. The result may be a more efficiently run work environment.

1. A computing system, comprising:
a storage device to store a graph with nodes to represent workers and edges representing relationships between the workers in a work environment; and
a processor to:
determine based on the graph information about the productivity of the work environment; and
determine a recommended change to the work environment based on the productivity information; and
output the recommendation.

2. The computing system of claim 1, wherein the recommend changes comprises a change to at least one of: a task, a worker, worker organization, or process workflow based on the productivity information.

3. The computing system of claim 1, wherein determining the productivity information comprises determining a priority level of a worker based on at least one of: the number of workers providing work to the worker, and the number of workers receiving work from the worker.

4. The computing system of claim 1, wherein the processor is further to compare a first graph of a first time period and a second graph of a second time period

5. The computing system of claim 1, wherein the processor is further to recommend a placement of at least a subset of the workers based on the determined productivity information.

6. A method comprising,
determining, by a computing device based on a graph representing relationships between workers, productivity information related to a work environment;
determining a suggested change to the work environment based on the productivity information; and
outputting the suggested change.

7. The method of claim 6, further comprising identifying based on the productivity information at least one of: relationships likely to result in failure and identifying relationships likely to result in success.

8. The method of claim 6, wherein the graph further represents tools shared between workers.

9. The method of claim 6, wherein determining productivity information comprises determining whether an interaction of a worker is related to the role of the worker.

10. The method of claim 6, wherein determining the productivity information comprises identifying an important worker relative to other workers.

11. A machine-readable non-transitory storage medium including instructions executable by a processor to:
determine productivity information related to a work environment based on analysis of a graph representative of interactions between workers;
determine a recommended change to the work environment based on the graph.
output the recommended change.

12. The machine-readable non-transitory storage medium of claim 11, wherein instructions to determine productivity information comprise instructions to compare the time between a workflow from a first worker to a second worker to the time spent performing the work.

13. The machine-readable non-transitory storage medium of claim 11, wherein instructions to determine the productivity information comprise instructions to trace work handed from a first worker to a second worker and back to the first worker.

14. The machine-readable non-transitory storage medium of claim 11, further comprising instructions to recommend a relative location of workers based on the productivity information.

15. The machine-readable non-transitory storage medium of claim 11, wherein the recommended change comprises a recommendation to group workers together for a common role based on the productivity information.
